(19) United States
(12) Patent Application Publication
(10) Pub. No.: US 2023/0254461 A1
(43) Pub. Date: Aug. 10, 2023

(54) IMAGE DISPLAY DEVICE AND CONTROL METHOD

(71) Applicant: SONY SEMICONDUCTOR SOLUTIONS CORPORATION, KANAGAWA (JP)

(72) Inventor: NAOTO MUNEMURA, KANAGAWA (JP)

(21) Appl. No.: 18/003,527

(22) PCT Filed: Jun. 22, 2021
(86) PCT No.: PCT/JP2021/023594

§ 371 Date: Dec. 28, 2022

(30) Foreign Application Priority Data
Jul. 7, 2020 (JP) 2020-117061

(51) Int. Cl. H04N 9/31; G03B 21/14; G03B 21/00

(52) U.S. Cl. CPC H04N 9/3167; H04N 9/3155; H04N 9/3185; G03B 21/147; G03B 21/006

(57) ABSTRACT

Provided are an image display device and a control method capable of suppressing image blurring without using a mechanical structure. An image display device capable of projecting an optical image includes: a reflection unit that reflects the optical image; a projection optical system that projects the optical image reflected; a detection unit that detects a motion of the image display device; and a control unit that controls a projection angle of the optical image by changing a reflection characteristic of a constituent material included in the reflection unit according to the motion.

### TECHNICAL FIELD

The present disclosure relates to an image display device and a control method.

### BACKGROUND ART

A technique for detecting vibration applied to an image display device and suppressing blurring of a projected image is generally known. The technique for suppressing blurring is performed by changing the direction of the optical member of the projection optical system. However, since a mechanical structure is required, a restriction of a response speed and a restriction of a volume may occur.

### CITATION LIST

### Patent Document

Patent Document 1: Japanese Patent Application Laid-Open No. 2017-191274

### SUMMARY OF THE INVENTION

### Problems to be Solved by the Invention

An object of the present invention is to provide an image display device and a control method capable of suppressing image blurring without using a mechanical structure.

### Solutions to Problems

An image display device according to the present disclosure for achieving the object described above is
an image display device capable of projecting an optical image, the image display device including:
a reflection unit that reflects the optical image;
a projection optical system that projects the optical image reflected;
a detection unit that detects a motion of the image display device; and
a control unit that controls a projection angle of the optical image by changing a reflection characteristic of a constituent material included in the reflection unit according to the motion.

The control unit may control the projection angle by changing an orientation of the constituent material.

The front reflection unit may include:
a plurality of pixel electrodes disposed in a matrix manner;
a counter electrode including a conductive film facing the plurality of pixel electrodes; and
the constituent material disposed on the plurality of pixel electrodes and the counter electrode, and
the control unit may control an orientation of the constituent material by changing a potential between the plurality of pixel electrodes and the counter electrode.

The control unit may change at least one of a position or a reflection angle of a reflection region in a reflection surface of the reflection unit by changing an orientation of the constituent material.

The control unit may control a position of a reflection region in the reflection unit by changing light transmittance of the constituent material.

The constituent material may be a phase modulation element.

The control unit may change an angle at which the optical image is reflected by changing an orientation of the phase modulation element.

The control unit may change a range in which the optical image is reflected by changing an orientation of the phase modulation element.

The image display device may further include an image generation unit that generates the optical image in a two-dimensional manner on the basis of a video signal, and
the control unit may change a relative position between a position where the optical image is generated and a position of a reflection region in the reflection unit according to the motion.

The image generation unit may include a liquid crystal panel in which transmittance or reflectance of light is controlled by the control unit on the basis of the video signal.

The control unit may change a position at which the optical image is generated to a position corresponding to the reflection region of the reflection unit.

The image display device further includes a second image generation unit that generates a second optical image in a two-dimensional manner on the basis of a video signal; and
a 2 reflection unit that reflects the second optical image,
the projection optical system may perform projection to superimpose the first optical image reflected and the second optical image reflected, and
the control unit may control at least one of the second image generation unit or the second reflection unit such that a projection angle of the second optical image projected from the projection optical shape is changed according to the motion.

A control method of an image display device according to the present disclosure for achieving the object described above is
a control method of an image display device including:
a reflection unit that reflects an optical image;
a projection optical system that projects the optical image reflected; and
a detection unit that detects a motion of the reflection unit,
in which the control method controls a projection angle of the optical image by changing an orientation of a member constituting the reflection unit according to the motion.

A control method of an image display device according to the present disclosure for achieving the object described above is
a control method of an image display device including:
a reflection unit that reflects an optical image;
a projection optical system that projects the optical image reflected; and
a detection unit that detects a motion of the reflection unit,
in which the control method controls a projection angle of the optical image by changing a position of the optical image incident on the reflection unit according to the motion.

### BRIEF DESCRIPTION OF DRAWINGS

FIG. 1 is a schematic diagram illustrating a configuration example of an image display device according to a first embodiment.

FIG. 2 is a front view schematically illustrating a light emission screen of an image generation unit.

FIG. 3 is a front view schematically illustrating a reflection screen of a reflection unit.

FIG. 4 is a diagram illustrating a configuration example of the reflection unit.

FIG. 5 is a diagram schematically illustrating a liquid crystal panel.

FIG. 6 is a block diagram illustrating a configuration example of a control unit.

FIG. 7 is a diagram schematically illustrating a horizontal direction and a vertical direction of the image display device.

FIG. 8 is a diagram schematically illustrating a position calculation example of an effective reflection area of the reflection unit 108.

FIG. 9 is a diagram schematically illustrating a reflection angle of a phase changing element of the reflection unit.

FIG. 10 is a diagram schematically illustrating a calculation example of a reflection angle θ of the effective reflection area of the reflection unit 108.

FIG. 11 is a diagram schematically illustrating a state in which the reflection angle of the phase changing element of is driven.

FIG. 12 is a diagram schematically illustrating a control example of a relative position between the effective reflection area and an effective display area.

FIG. 13 is a diagram schematically illustrating a control example of a relative position between the effective reflection area and the effective display area and the reflection angle of the phase changing element.

FIG. 14 is a flowchart illustrating a flow of processing of the control unit.

FIG. 15 is a block diagram illustrating a configuration example of a control unit according to a 2 embodiment.

FIG. 16 is a flowchart illustrating a flow of processing of the control unit including movement determination processing based on statistics.

FIG. 17 is a schematic diagram illustrating a configuration example of an image display device according to a first modification of the second embodiment.

FIG. 18 is a schematic diagram illustrating a configuration example of an image display device according to a second modification of the second embodiment.

FIG. 19 is a schematic diagram illustrating a configuration example of an image display device 1c according to a third modification of the second embodiment.

### MODE FOR CARRYING OUT THE INVENTION

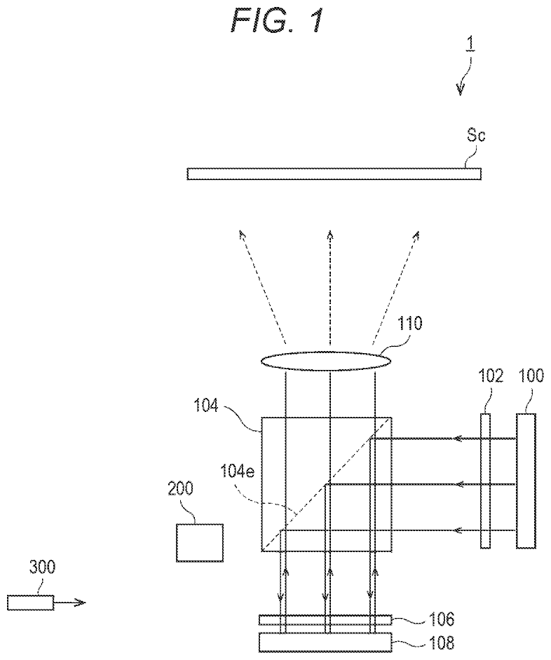

Under various conditions in the present specification, the presence of various variations occurring in design or manufacturing is allowed. Furthermore, the drawings used in the following description are schematic. For example, FIG. 1 described later illustrates a structure of an image display device, but does not illustrate a ratio of a width, a height, a thickness, or the like.

### First Embodiment

FIG. 1 is a schematic diagram illustrating a configuration example of an image display device 1 according to a first embodiment. The image display device 1 is a device capable of projecting an image on the basis of a video signal, and includes an image generation unit 100, a polarizing plate 102, a polarizing beam splitter 104, a phase plate 106, a reflection unit 108, a projection optical system 110, a detection unit 200, and a control unit 300. FIG. 1 further illustrates a screen Sc.

The image generation unit 100 is, for example, a self-luminous liquid crystal panel. This liquid crystal panel shields, for example, light of a backlight for each subpixel by a liquid crystal shutter that shields the light according to R, G, and B luminance signals. The light transmitted through the liquid crystal shutter generates a two-dimensional optical image by, for example, a color filter or the like. Note that, in the present embodiment, a liquid crystal panel is used for the image generation unit 100, but the present invention is not limited thereto. For example, an image display device such as an organic EL may be used.

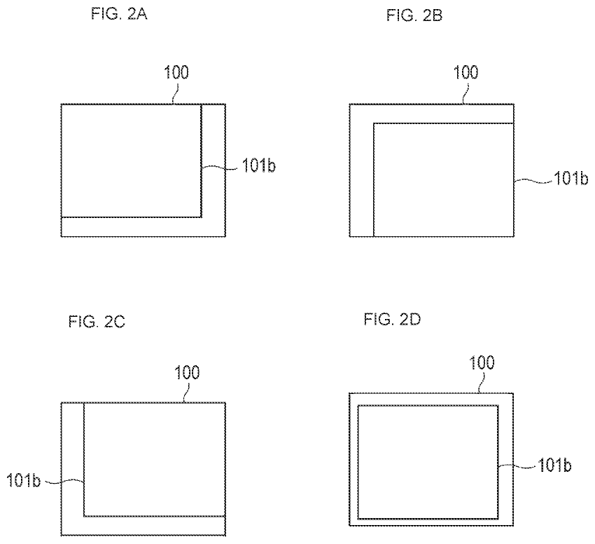

FIG. 2 is a front view schematically illustrating a light emission screen of the image generation unit 100. The light emission screen of the image generation unit 100 can generate an optical image in a wider range than an effective display area 101b. FIGS. (a) to (d) illustrate examples in which the position of the effective display area 101b is changed under the control of the control unit 300.

Returning to FIG. 1 again, the polarizing plate 102 polarizes the optical image irradiated from the image generation unit 100 into light in a first polarization state, for example, P light (hereinafter, it may be referred to as P light).

The polarizing beam splitter 104 reflects the optical image (P light) through the polarizing plate 102 by an interface 104e formed with an optical thin film or the like, and emits the reflected image to the phase plate 106.

The phase plate 106 polarizes the incident optical image into circularly polarized light, polarizes the optical image reflected by the reflection unit 108 into light in a second polarization state, for example, S light (hereinafter, it may be referred to as S light), and emits the light to the polarizing beam splitter 15. The optical image (S light) is transmitted through an interface 15e of the polarizing beam splitter 15 and is incident on the projection optical system 110.

The projection optical system 110 is, for example, a compound lens, and projects an incident optical image on the screen Sc.

The reflection unit 108 includes a phase polarizing element, for example, a reflective display panel such as a liquid crystal on silicon (LCOS, LCOS is a registered trademark) or the like.

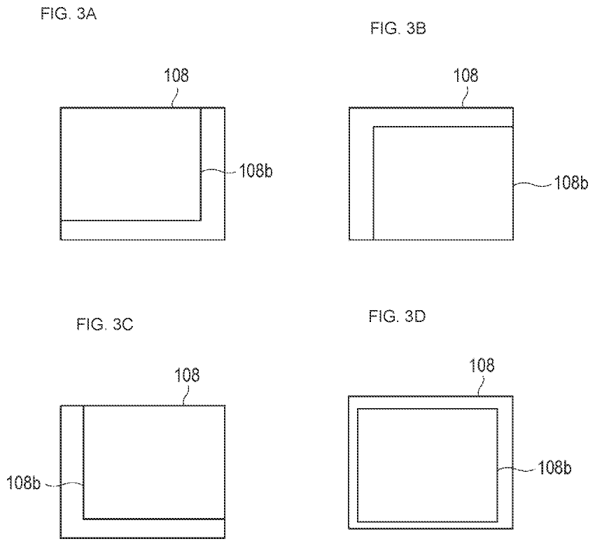

FIG. 3 is a front view schematically illustrating a reflection screen of the reflection unit 108. The reflection range of the reflection unit 108 can reflect an optical image in a wider range than an effective reflection area 108b. Figs. (a) to (d) illustrate an example in which the position of the effective reflection area 100b is changed under the control of the control unit 300. Furthermore, the control unit 300 can change the reflection direction by controlling the orientation of the liquid crystal layer (constituent material) in the effective reflection area 108b.

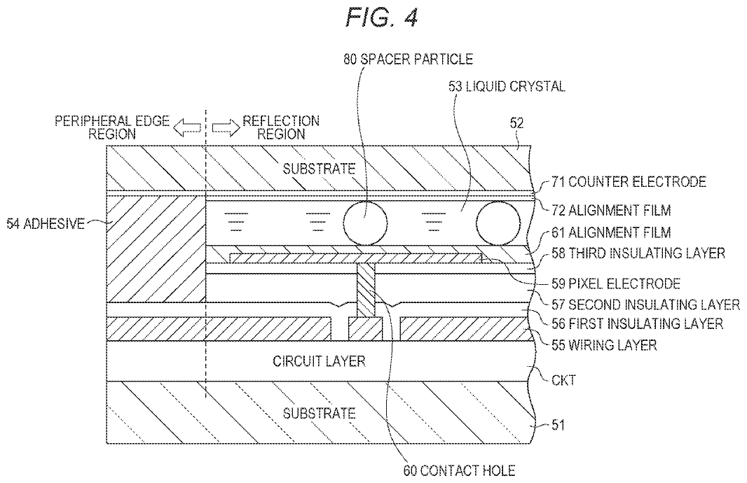

FIG. 4 is a diagram illustrating a configuration example of the reflection unit 108. FIG. 4 schematically illustrates a liquid crystal panel having an LCOS structure suitable for thickness reduction as an example of the liquid crystal panel. As illustrated in the drawing, the liquid crystal panel includes a pair of substrates 51 and 52 bonded to each other by an adhesive 54 with a gap interposed therebetween, and a liquid crystal 53 held in the gap, and has a reflection region that reflects an image by the liquid crystal, and a peripheral edge region that surrounds the reflection region and in which the adhesive 54 is disposed. The thickness of the liquid crystal 53 is controlled to 2 μm or less.

A scanning line, a signal line, and a pixel circuit including a switching element disposed at an intersection of the scanning line and the signal line and a pixel electrode connected thereto are formed in a reflection region of the lower silicon substrate 51, and a drive circuit that drives the switching element via the scanning line and the signal line is integrally formed in a peripheral edge region. In the drawing, a switching element including a MOSFET is formed in a display region of a circuit layer CKT on the surface of the silicon substrate 51, and a drive circuit similarly including a MOSFET is integrally formed in a peripheral edge region. In addition, the signal line and the like are formed in a wiring layer 55 on the circuit layer CKT. A pixel electrode 59 is formed on the wiring layer 55 with a first insulating layer 56, a second insulating layer 57, and a third insulating layer 58 interposed therebetween. The pixel electrode 59 is connected to the wiring layer 55 via a contact hole 60 opened in the three insulating layers. An alignment film 61 for controlling alignment of the liquid crystal 53 is formed on the pixel electrode 59. Meanwhile, a counter electrode 71 including a transparent conductive film is formed on the glass substrate 52 so as to face the pixel electrode 59, and the surface thereof is covered with an alignment film 72. The liquid crystal 53 described above is held between each pixel electrode 59 and the counter electrode 71. The control unit 300 controls the voltage applied to each pixel electrode 59 and the counter electrode 71 to control the alignment of the liquid crystal 53 and control the reflection direction. Note that the liquid crystal 53 according to the present embodiment corresponds to a phase polarizing element.

Returning to FIG. 1 again, the detection unit 200 detects the movement amount applied to the image display device 1. The detection unit 200 includes, for example, a three-axis acceleration sensor. The detection unit 200 outputs a detection signal including displacement information M that is a detection result of detecting the displacement to the control unit 300.

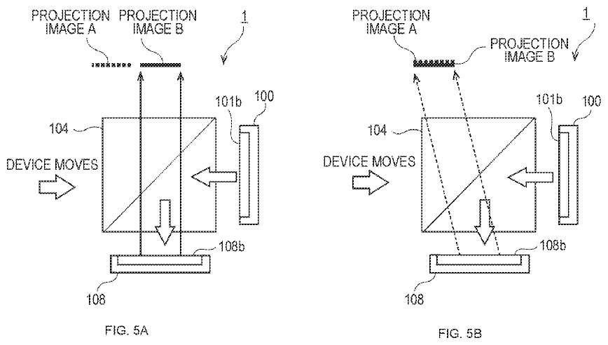

The control unit 300 controls the reflection direction of the reflection unit 108 on the basis of the detection signal of the detection unit 200. FIG. 5 is a schematic diagram illustrating a control example of the reflection direction. Note that, in FIG. 5, description of a configuration excluding the image generation unit 100, the polarizing beam splitter 104, and the reflection unit 108 is omitted. Fig. (a) of FIG. 4 is a diagram schematically illustrating an example in which the reflection direction, that is, the projection angle of the optical image is not controlled, and Fig. (b) is a diagram schematically illustrating an example in which the reflection direction, that is, the projection angle of the optical image is controlled. For example, a projection image A is a projection image projected before the image display device 1 moves, and a projection image B is a projection image projected after the image display device 1 moves. As described above, the control unit 300 controls the reflection direction such that the projection view B is projected at the position before the movement even if the image display device 1 moves.

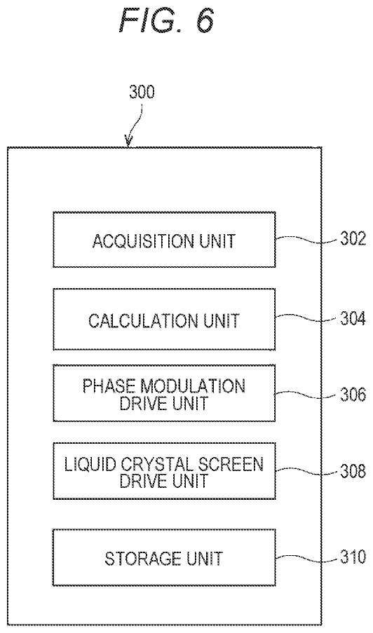

FIG. 6 is a block diagram illustrating a configuration example of the control unit 300. As illustrated in FIG. 6, the control unit 300 includes, for example, a central processing unit (CPU), and includes an acquisition unit 302, a calculation unit 304, a phase modulation drive unit 306, a liquid crystal screen drive unit 308, and a storage unit 310. The storage unit 310 stores various programs for executing the control operation. Therefore, the control unit 300 configures each unit, for example, by executing a program stored in the storage unit 310.

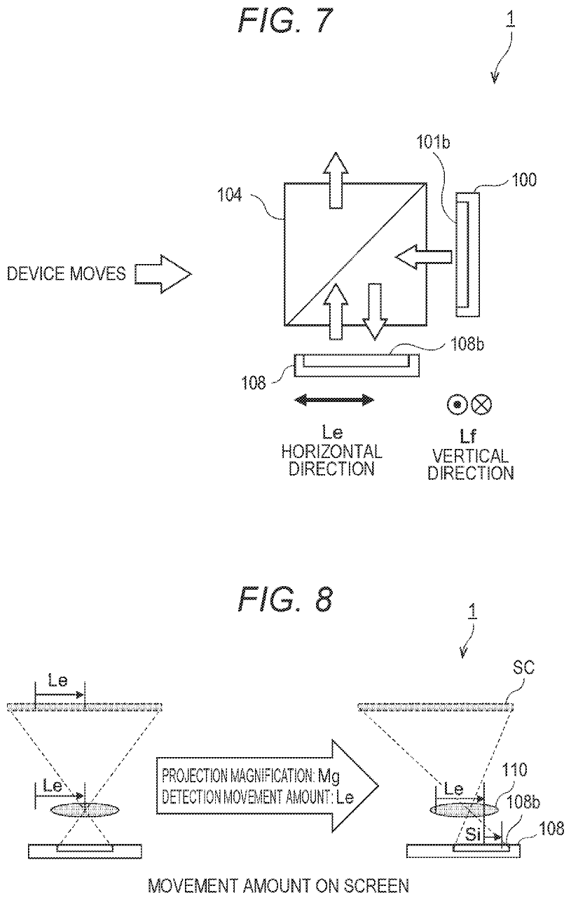

FIG. 7 is a diagram schematically illustrating a movement distance Le in the horizontal direction and a movement distance Lf in the vertical direction of the image display device 1 included in displacement information M. As illustrated in FIG. 7, the acquisition unit 302 acquires information of the movement amount Le in the horizontal direction and the movement amount Lf in the vertical direction in the horizontal plane on the basis of the detection signal of the detection unit 200.

FIG. 8 is a diagram schematically illustrating a position calculation example of the effective reflection area 108 of the reflection unit 108. In FIG. 7, the projection magnification of the projection optical system (see FIG. 1) is Mg, the movement amount in the horizontal direction is Le, and the movement amount in the vertical direction is Lf. From the geometric relationship, the calculation unit 304 calculates the movement amount Sx in the horizontal direction and the movement amount Sy in the vertical direction of the effective reflection area 108b according to Formulas (1) and (2).

### [Mathematical Formula 1]

Sx=Le/Mg (1)

### [Mathematical Formula 2]

Sx=Le/Mg (2)

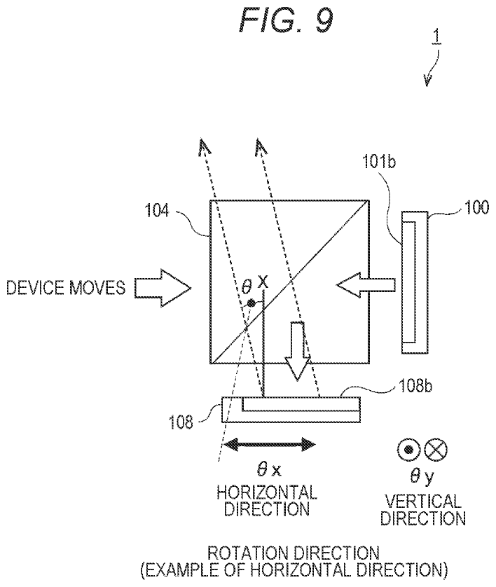

FIG. 9 is a diagram schematically illustrating a reflection angle θ of the phase changing element of the reflection unit 108. As illustrated in FIG. 9, the calculation unit 304 calculates the horizontal direction reflection angle θx and the vertical direction reflection angle θy on the basis of the information of the movement amount Le and the movement amount Lf.

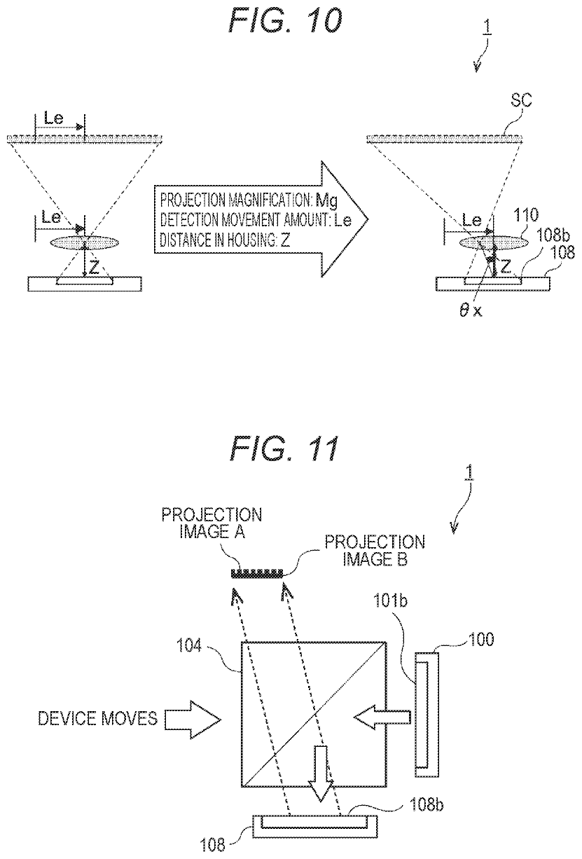

FIG. 10 is a diagram schematically illustrating a calculation example of the reflection angle θx of the effective reflection area 108 of the reflection unit 108. In FIG. 10, the projection magnification of the projection optical system (see FIG. 1) is Mg, the movement amount in the direction is Le, and the distance between the optical center of the projection optical system 110 and the effective reflection area 108b of the reflection unit 108 is Z. From the geometric relationship, the calculation unit 304 calculates the reflection angles θx and θy of the effective reflection area 108 according to Formulas (3) and (4).

### [Mathematical Formula 3]

θx=TAN⁻¹{Le/(Mg×Z)} (3)

### [Mathematical Formula 4]

θy=TAN⁻¹{(Lf/(Mg×Z)} (4)

The calculation unit 304 may store the calculation results for Formulas (1) to (4) for the movement amounts Le and Lf in the storage unit in advance as a table. In this case, the calculation unit 304 reads the movement amounts Sx and Sy and the reflection angles θx and θy corresponding to the movement amounts Le and Lf from the storage unit and performs processing. Therefore, calculation becomes unnecessary, and the processing speed becomes faster.

FIG. 11 is a diagram schematically illustrating a state in which the phase modulation drive unit 306 drives the reflection angle θ of the phase changing element of the reflection unit 108.

On the basis of the reflection angles θx and θy of the effective reflection area 108b calculated by the calculation unit 304, the phase modulation drive unit 306 controls the voltage applied to the phase changing element of the reflection unit 108 for each pixel. For example, the phase modulation drive unit 306 controls the voltage between each pixel electrode 59 and the counter electrode 71 (see FIG. 4) for each pixel. As illustrated in FIG. 11, the orientation of liquid crystal 53 is changed by changing the voltage between each pixel electrode 59 and counter electrode 71 (see FIG. 4). Therefore, the reflection angles θx and θy are changed.

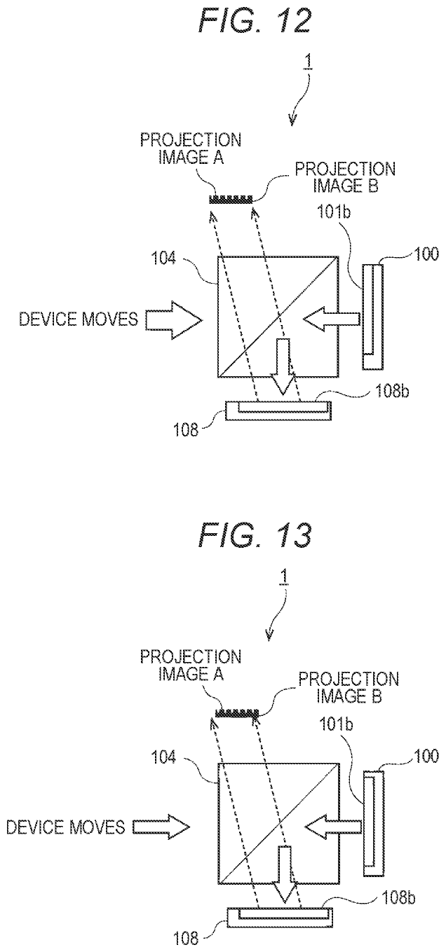

FIG. 12 is a diagram schematically illustrating a control example of the relative position between the effective reflection area 108b of the reflection unit 108 and the effective display area 101b of the image generation unit 100. As illustrated in FIG. 12, the phase modulation drive unit 306 controls the position of the effective reflection area 108b on the basis of the movement amounts Sx and Sy of the effective reflection area 108b calculated by the calculation unit 304. More specifically, for example, the voltage applied to each pixel electrode 59 and the counter electrode 71 (see FIG. 4) is controlled, and the region other than the effective reflection area 108b is shielded by the alignment control of the liquid crystal 53 (see FIG. 4). As described above, the position of the effective reflection area 108b is controlled by changing the transmittance of the liquid crystal 53 as a constituent material.

As illustrated in FIG. 12, the liquid crystal screen drive unit 308 drives the relative position of the effective display area 101b to a position where the optical image is projected onto the effective reflection area 108b on the basis of the movement amounts Sx and Sy of the effective reflection area 108b calculated by the calculation unit 304.

FIG. 13 is a diagram schematically illustrating a control example of the relative position between the effective reflection area 108b of the reflection unit 108 and the effective display area 101b of the image generation unit 100, and the reflection angle θ of the phase changing element. On the basis of the reflection angles θx and θy of the effective reflection area 108b calculated by the calculation unit 304, the phase modulation drive unit 306 controls the voltage applied to the phase changing element of the reflection unit 108, for example, each pixel electrode 59 and the counter electrode 71 (see FIG. 4). Furthermore, a region other than the region of the effective reflection area 108b is shielded from light. The liquid crystal screen drive unit 308 drives the relative position of the effective display area 101b to a position where the optical image is projected onto the effective reflection area 108b on the basis of the movement amounts Sx and Sy of the effective reflection area 108b calculated by the calculation unit 304.

As described above, the control unit 300 has a first mode in which the reflection angles θx and θy of the phase changing element are controlled, a second mode in which the relative positions of the effective reflection area 108b of the reflection unit 108 and the effective display area 101b of the image generation unit 100 are controlled, and a third mode in which the first mode and the second mode are performed in parallel. Furthermore, in the second mode, the position of at least one of the effective reflection area 108b or the effective display area 101b is changed.

The storage unit 204 includes, for example, a hard disk drive (HDD), a solid state drive (SSD), or the like.

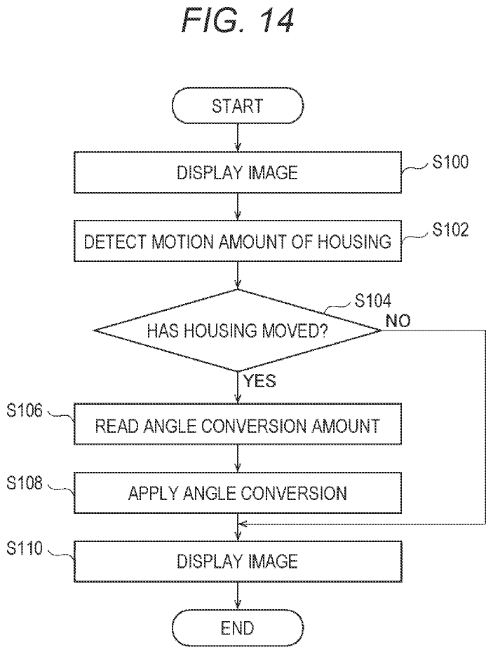

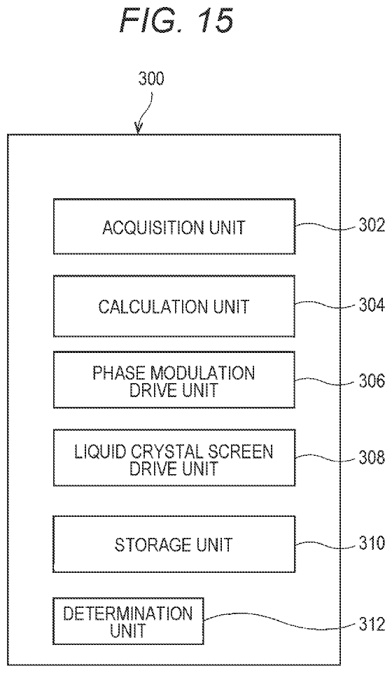

FIG. 14 is a flowchart illustrating a flow of processing of the control unit 300.

First, the control unit 300 controls the image generation unit 100 and the reflection unit 108 to display the secondary optical image as the projection image A (step S100).

Next, the detection unit 200 outputs the displacement information M detected by the acceleration sensor to the calculation unit 304 (step S102).

Next, the calculation unit 304 determines whether or not the image display device 1 has moved on the basis of the displacement information M (step S104). In a case where it is determined that the image display device 1 has moved (Yes in step S104), the calculation unit 304 reads the movement amounts Sx and Sy and the reflection angles θx and θy corresponding to the movement amounts Le and Lf from the storage unit 310 (step S106).

Next, the phase modulation drive unit 306 controls the applied voltage in the reflection unit 108 on the basis of the movement amounts Sx and Sy and the reflection angles θx and θy, and changes the position of the reflection unit 108 effective reflection area 108b and the reflection angles θx and θy. At the same time, the liquid crystal screen drive unit 308 controls the position of the effective display area 101b on the basis of the movement amounts Sx and Sy (step S108).

Meanwhile, in a case where the calculation unit 304 determines that the image display device 1 has not moved (No in step S104), the phase modulation drive unit 306 and the liquid crystal screen drive unit 308 maintain the effective reflection area 108b, the reflection angles θx and θy, and the effective display area 101b without changing.

Next, the secondary optical image generated in the effective display area 101b of the image generation unit 100 is reflected by the effective reflection area 108b of the reflection unit 108, and is projected on the screen Sc as the projection image B via the projection optical system 110 (step S108), and the process ends.

As described above, according to the present embodiment, by changing at least one of the position of the effective reflection area 108b of the reflection unit 108 or the reflection angles θx and θy according to the movement amount of the image display device 1 by the detection unit 200, the projection angle of the projection image B projected via the projection optical system 110 is changed. Therefore, it is possible to suppress the blurring of the projection image B at a higher speed only by controlling the applied voltage in the reflection unit 108 without using a mechanical mechanism.

### Second Embodiment

An image display device 1 according to the second embodiment is different from the image display device 1 according to the first embodiment in that the movement determination processing of the image display device 1 based on statistics can be further performed. Hereinafter, differences from the image display device 1 according to the first embodiment will be described.

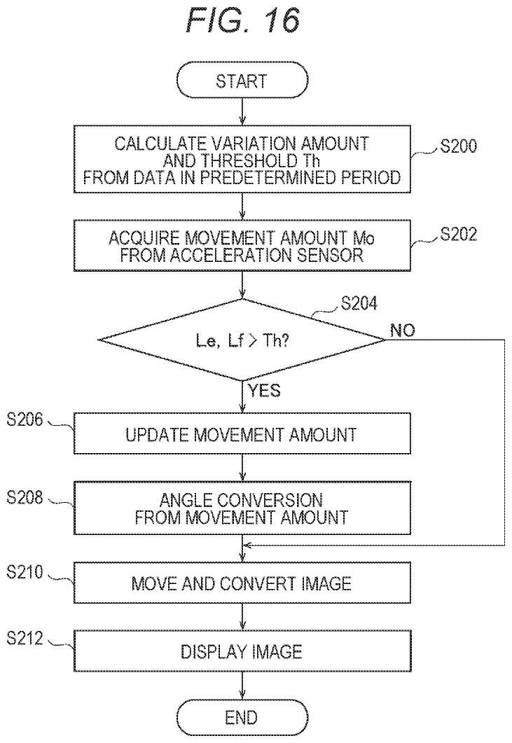

FIG. 16 is a block diagram illustrating a configuration example of the control unit 300 according to the second embodiment. As illustrated in FIG. 16, the control unit 300 according to the second embodiment further includes a determination unit 312.

The control unit 300 performs determination processing of the presence or absence of movement of the image display device 1 on the basis of the statistics of the movement amount Le in the horizontal direction and the movement amount Lf in the vertical direction within a predetermined period. More specifically, the average value and the standard deviation of the movement amount Le and the movement amount Lf in the vertical direction within a predetermined period, for example, 300 seconds are calculated, and in a case where any one of the movement amount Le or the vertical movement amount Lf acquired by the acquisition unit exceeds, for example, 4σ, it is determined that the image display device 1 has moved.

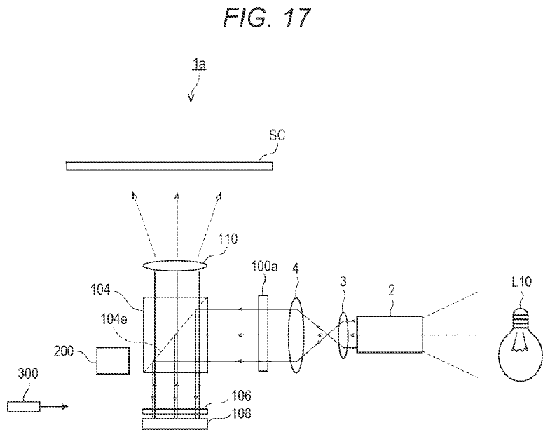

FIG. 17 is a flowchart illustrating a flow of processing of the control unit 300 including movement determination processing based on statistics.

First, the determination unit 312 calculates the standard deviation σ of each of the horizontal movement amount Le and the vertical movement amount Lf within a predetermined period detected by the detection unit 200, and sets values of the horizontal movement amount Le and the vertical movement amount Lf corresponding to 4σ as a threshold Th (step S200). Here, the thresholds of the horizontal movement amount Le and the vertical movement amount Lf are both set as Th.

Next, the determination unit 312 acquires displacement information M0 including the horizontal movement amount Le and the vertical movement amount Lf detected by the detection unit 200 via the acquisition unit 302 (step S202).

Next, the determination unit 312 determines whether or not each of the horizontal movement amount Le and the vertical movement amount Lf included in the displacement information M0 exceeds the threshold Th (step S204). In a case where either the horizontal movement amount Le or the vertical movement amount Lf exceeds the threshold Th, the determination unit 312 determines that there is movement (Yes in step S204).

In a case where it is determined that there is movement, the calculation unit 304 updates the information of the horizontal movement amount Le and the vertical movement amount Lf to the latest information (step S206), and calculates the movement amounts Sx and Sy and the reflection angles θx and θy using Formulas (1) to (4) on the basis of the latest horizontal movement amount Le and vertical movement amount Lf (step S208).

Next, the phase modulation drive unit 306 controls the applied voltage in the reflection unit 108 on the basis of the movement amounts Sx and Sy and the reflection angles θx and θy, and changes the position of the reflection unit 108 effective reflection area 108b and the reflection angles θx and θy. At the same time, the liquid crystal screen drive unit 308 controls the position of the effective display area 101b on the basis of the movement amounts Sx and Sy (step S210).

Meanwhile, in a case where the calculation unit 304 determines that the image display device 1 has not moved (No in step S204), the phase modulation drive unit 306 and the liquid crystal screen drive unit 308 maintain the effective reflection area 108b, the reflection angles θx and θy, and the effective display area 101b without changing.

Next, the secondary optical image generated in the effective display area 101b of the image generation unit 100 is reflected by the effective reflection area 108b of the reflection unit 108, and is projected on the screen Sc as the projection image B via the projection optical system 110 (step S212), and the process ends.

As described above, according to the present embodiment, the determination unit 312 determines the movement of the image display device 1 on the basis of the statistics of the horizontal movement amount Le and the vertical movement amount Lf within the predetermined period. Therefore, the movement determination accuracy of the image display device 1 is further improved, and unnecessary blur correction can be suppressed.

### First Modification of Second Embodiment

A difference between an image display device 1a according to a first modification of the second embodiment and the image display device 1 according to the second embodiment will be described as using a transmissive liquid crystal image display device for an image generation unit 100a.

FIG. 17 is a schematic diagram illustrating a configuration example of the image display device 1a according to the first modification of the second embodiment.

The image display device 1a is different from the image display device 1 according to the second embodiment in that the image display device la includes a light source L10 that generates and irradiates light, a glass rod 2 for mixing incident light irradiated from the light source L10 into a uniform light flux, a focusing lens 3, a collimating lens 4, and an image generation unit 100a.

The image generation unit 100a of the image display device la includes a so-called transmissive liquid crystal panel. Liquid crystal display elements R, G, and B of the liquid crystal panel are transmissive light modulation devices corresponding to primary colors of R, G, and B, respectively, and include pixels arranged in a matrix of, for example, 1080 rows long and 1920 columns wide in a rectangular pixel region. In each pixel, the amount of transmitted light with respect to the incident light from the collimating lens 4 is adjusted.

Furthermore, in the liquid crystal display elements R, G, and B, a scanning line and a data line are provided corresponding to each pixel, and a liquid crystal is disposed between a pixel electrode corresponding to a position where the scanning line and the data line intersect with each other and a common electrode disposed opposite to the pixel electrode. The liquid crystal screen drive unit 308 controls a voltage applied to the pixel electrode and the common electrode disposed opposite to the pixel electrode to generate a two-dimensional optical image. Similarly to FIG. 2, the light emission screen of the image generation unit 100a can generate an optical image in a wider range than the effective display area 101b. Therefore, the position of the effective display area 101b can be changed by the control of the control unit 300.

In addition, each of the liquid crystal display elements liquid crystal display elements R, G, and B is provided with a polarizing plate. Therefore, the optical image generated by the image generation unit 100a is polarized into the light in the first polarization state, for example, P light. As described above, it is also possible to use a transmissive liquid crystal image display device for the image generation unit 100a.

### Second Modification of Second Embodiment

A difference between the image display device 1b according to a second modification of the second embodiment and the image display device 1 according to the second embodiment will be described as using a reflective liquid crystal panel for an image generation unit 100b.

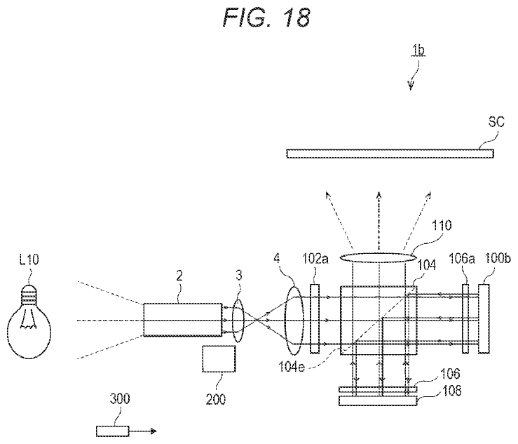

FIG. 18 is a schematic diagram illustrating a configuration example of the image display device 1b according to the second modification of the second embodiment.

The image display device 1b is different from the image display device 1 according to the second embodiment in that the image display device 1b includes a light source L10 that generates and irradiates light, a glass rod 2 for mixing incident light irradiated from the light source L10 into a uniform light flux, a focusing lens 3, a collimating lens 4, an image generation unit 100b, a polarizing plate 102a, and a phase plate 106a.

The polarizing plate 102a polarizes incident light from the glass rod 2 into light in the first polarization state, for example, S light, and emits the light to the polarizing beam splitter 104. The S light through the polarizing plate 102a passes through the interface 104e and enters the phase plate 106a.

The phase plate 106a circularly polarizes the incident light, and polarizes the optical image reflected from the image generation unit 100b into light in the first polarization state, for example, P light.

The image generation unit 100b includes a liquid crystal panel. LCOS can be used for the liquid crystal panel. In the LCOS, a light reflective pixel electrode and a drive circuit for driving the pixel electrode are integrally formed on a silicon substrate. The liquid crystal screen drive unit 308 controls a voltage applied to the pixel electrode of the liquid crystal panel and a common electrode disposed opposite to the pixel electrode to generate a two-dimensional optical image. Similarly to FIG. 2, the reflection screen of the image generation unit 100b can generate an optical image in a wider range than the effective display area 101b. Therefore, the position of the effective display area 101b can be changed by the control of the control unit 300. As described above, it is also possible to use a reflective liquid crystal panel for the image generation unit 100b.

### Third Modification of Second Embodiment

A difference between an image display device 1b according to a third modification of the second embodiment and the image display device 1 according to the second embodiment will be described as superimposing two optical images generated by an image generation unit.

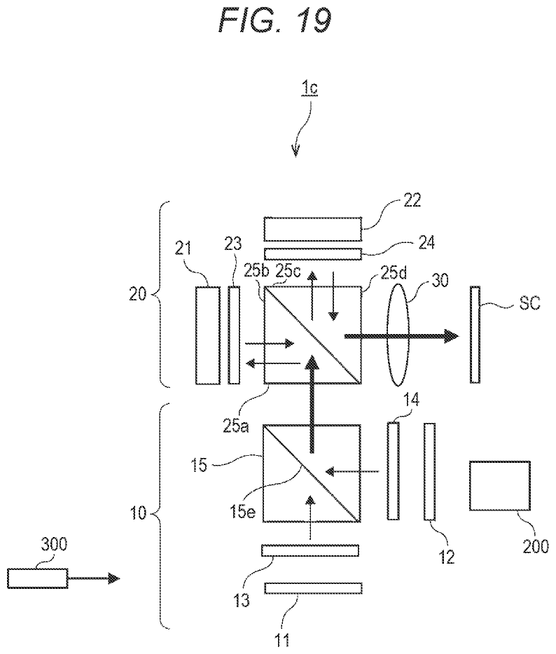

FIG. 19 is a schematic diagram illustrating a configuration example of the image display device 1c according to the third modification of the second embodiment. The image display device c1 is a device capable of projecting an image on the basis of a video signal, and includes a light irradiation unit 10, a superimposition unit 20, a projection unit 30, and a control unit 40.

The light irradiation unit 10 can emit a plurality of color lights, and includes a first image generation unit 11, a second image generation unit 12, polarizing plates 13 and 14, and a light irradiation polarizing beam splitter 15. The first image generation unit 11 is a so-called self-luminous liquid crystal panel, and generates a red optical image 11R and a blue optical image 11B. The 2 image generation unit 12 is a so-called self-luminous liquid crystal panel, and generates a green optical image 12G and a blue optical image 12B. The second image generation unit 12 can generate an optical image of complementary color light of one of the red optical image 11R or the blue optical image 11B generated by the first image generation unit 11. Similarly to FIG. 2, the light emission screens of the first image generation unit 11 and the second image generation unit 12 can generate an optical image in a wider range than the effective display area 101b. Therefore, the position of the effective display area 101b can be changed by the control of the control unit 300.

The polarizing plate 13 polarizes the light irradiated from the first image generation unit 11 into light in the first polarization state, for example, P light (hereinafter, it may be referred to as P light). Furthermore, the polarizing plate 14 polarizes the light irradiated from the second image generation unit 12 into light in the second polarization state, for example, S light (hereinafter, it may be referred to as S light).

The light irradiation polarizing beam splitter 15 includes a first incident surface 15a on which the light from the first image generation unit 11 is incident, a second incident surface 15d on which the light from the second image generation unit 12 is incident, and an emission surface 15c from which the light from the first image generation unit 11 and the second image generation unit 12 is emitted. The irradiation polarizing beam splitter 15 further has a surface 15b, which is not involved in light irradiation.

Furthermore, reference numeral 15e denotes an interface formed by an optical thin film or the like in the light irradiation polarizing beam splitter 15. As described above, the polarizing plate 13 that brings the irradiation light into the first polarization state is disposed between the first image generation unit 11 and the light irradiation polarizing beam splitter 15. Furthermore, the polarizing plate 14 that brings the irradiation light into the second polarization state is disposed between the second image generation unit 12 and the light irradiation polarizing beam splitter 15.

The light (P light) of the first image generation unit 11 via the polarizing plate 13 travels straight through the light irradiation polarizing beam splitter 15 and is emitted from the emission surface 15c. Meanwhile, the light (S light) of the second image generation unit 12 via the polarizing plate 14 is reflected by the interface 15e and emitted from the emission surface 15c.

The superimposition unit 20 includes a first display panel 21, a second display panel 22, wave plates 23 and 24, and a polarizing beam splitter 25. For example, the first display panel 21 and the second display panel 22 include a reflective display panel such as a liquid crystal on silicon (LCOS, LCOS is a registered trademark) or the like. The first display panel 21 is sequentially driven by a video signal corresponding to at least one of a red signal or a blue signal which are color signals corresponding to the red optical image 11R and the blue optical image 11B generated by the first image generation unit 11. Similarly, the second display panel 22 is sequentially driven by a video signal corresponding to at least one of a green signal or a blue signal which are color signals corresponding to the green optical image 12G and the blue optical image 12B generated by the second image generation unit 12. The wave plates 23 and 24 are λ/4 plates. Note that the first display panel 21 and the second display panel 22 may include a transmissive display panel.

Similarly to FIG. 3, the reflection ranges of the first display panel 21 and the second display panel 22 can reflect an optical image in a wider range than the effective reflection area 108b. In the first display panel 21 and the second display panel 22, the control unit 30 controls the position of the effective reflection indication area 100b by controlling the orientation of the liquid crystal layer as a constituent material. Furthermore, the control unit 300 changes the reflection direction by controlling the orientation of the liquid crystal layer as a constituent material in the effective reflection area 108b. Note that the first display panel 21 according to the present embodiment corresponds to a reflection unit, and the second display panel 22 corresponds to a second reflection unit.

The polarizing beam splitter 25 has a first surface (denoted by reference numeral 25a) on which the light from the light irradiation unit 10 is incident, a second surface (denoted by reference numeral 25b) and a third surface (denoted by reference numeral 25c) from which the incident light is emitted, and a fourth surface (denoted by reference numeral 25d) from which the light through the first display panel 21 and the light through the second display panel 22 are emitted. Reference numeral 25e denotes an interface due to an optical thin film or the like in the polarizing beam splitter 25. The first display panel 21 is disposed so as to face the second surface 25b, and the second display panel 22 is disposed so as to face the third surface 25c. Furthermore, the wave plates 23 and 24 are disposed between the second surface 25b of the polarizing beam splitter 25 and the first display panel 21 and between the third surface 25c of the polarizing beam splitter 25 and the second display panel 22.

The projection unit 30 is, for example, a lens. The projection unit 30 is disposed on the fourth surface side of the polarizing beam splitter 25.

The light (P light) in the first polarization state irradiated from the light irradiation unit 10 is reflected by the interface 25e, and the light in the second polarization state travels straight without being reflected. Therefore, the light (P light) in the first polarization state is emitted from the second surface 25b of the polarizing beam splitter 25, and the light (S light) in the second polarization state is emitted from the third surface 25c of the polarizing beam splitter 25.

The light emitted from the second surface 25b of the polarizing beam splitter 25 reaches the first display panel 21 via the wave plate 23. The first display panel 21 acts as a light valve, and light whose luminance is controlled according to a video signal is incident on the second surface 25b of the polarizing beam splitter 25 via the wave plate 23. The reflected light travels straight in the polarizing beam splitter 25 and is emitted from the fourth surface 25d to form a first image. Furthermore, the light emitted from the third surface 25c of the polarizing beam splitter 25 reaches the second display panel 22 via the wave plate 24. The second display panel 22 acts as a light valve, and light whose luminance is controlled according to a video signal is incident on the third surface 25c of the polarizing beam splitter 25 via the wave plate 24. The reflected light is reflected by the interface 25e and emitted from the fourth surface 25d to form a second image. Therefore, an image in which the first image and the second image are superimposed is displayed on the screen Sc.

By changing at least one of the positions of effective reflection areas 108b of the first display panel 21 and the second display panel 22 or the reflection angles θx and θy according to the movement amount of the image display device 1c detected by detection unit 200, the projection angle of the projection image projected through the projection unit 30 can be changed. Furthermore, the positions of the effective display areas 101b of the first image generation unit 11 and the second image generation unit 12 are controlled in accordance with the positions of the effective reflection areas 108b of the first display panel 21 and the second display panel 22. Therefore, only by controlling the applied voltage in the first display panel 21 and the second display panel 22, the blurring of the projection image can be suppressed at a higher speed without using a mechanical mechanism.

Note that the present technology can have the following configurations.

(1) An image display device capable of projecting an optical image, the image display device including:
a reflection unit that reflects the optical image;
a projection optical system that projects the optical image reflected;
a detection unit that detects a motion of the image display device; and
a control unit that controls a projection angle of the optical image by changing a reflection characteristic of a constituent material included in the reflection unit according to the motion.

(2) The image display device according to (1),
in which the control unit controls the projection angle by changing an orientation of the constituent material.

(3) The image display device according to (1) or (2),
in which the front reflection unit includes:
a plurality of pixel electrodes disposed in a matrix manner;
a counter electrode including a conductive film facing the plurality of pixel electrodes; and
the constituent material disposed on the plurality of pixel electrodes and the counter electrode, and
the control unit controls an orientation of the constituent material by changing a potential between the plurality of pixel electrodes and the counter electrode.

(4) The image display device according to any one of (1) to (3),
in which the control unit changes at least one of a position or a reflection angle of a reflection region in a reflection surface of the reflection unit by changing an orientation of the constituent material.

(5) The image display device according to any one of (1) to (4),
in which the control unit controls a position of a reflection region in the reflection unit by changing light transmittance of the constituent material.

(6) The image display device according to any one of (1) to (5),
in which the constituent material is a phase modulation element.

(7) The image display device according to (6),
in which the control unit changes an angle at which the optical image is reflected by changing an orientation of the phase modulation element.

(8) The image display device according to (6) or (7),
in which the control unit changes a range in which the optical image is reflected by changing an orientation of the phase modulation element.

(9) The image display device according to any one of (1) to (8), further including
an image generation unit that generates the optical image in a two-dimensional manner on the basis of a video signal,
in which the control unit changes a relative position between a position where the optical image is generated and a position of a reflection region in the reflection unit according to the motion.

(10) The image display device according to (9),
in which the image generation unit includes a liquid crystal panel in which transmittance or reflectance of light is controlled by the control unit on the basis of the video signal.

(11) The image display device according to (9) or (10),
in which the control unit changes a position at which the optical image is generated to a position corresponding to the reflection region of the reflection unit.

(12) The image display device according to any one of (1) to (11),
in which the control unit changes the projection angle on the basis of a statistic of a movement amount detected by the detection unit in a predetermined period.

(13) The image display device according to any one of (1) to (12), further including
a second image generation unit that generates a second optical image in a two-dimensional manner on the basis of a video signal; and
a 2 reflection unit that reflects the second optical image,
in which the projection optical system performs projection to superimpose the first optical image reflected and the second optical image reflected, and
the control unit controls at least one of the second image generation unit or the second reflection unit such that a projection angle of the second optical image projected from the projection optical shape is changed according to the motion.

(14) A control method of an image display device including:
a reflection unit that reflects an optical image;
a projection optical system that projects the optical image reflected; and
a detection unit that detects a motion of the reflection unit,
in which the control method controls a projection angle of the optical image by changing an orientation of a member constituting the reflection unit according to the motion.

(15) A control method of an image display device including:
a reflection unit that reflects an optical image;
a projection optical system that projects the optical image reflected; and
a detection unit that detects a motion of the reflection unit,
in which the control method controls a projection angle of the optical image by changing a position of the optical image incident on the reflection unit according to the motion.

### REFERENCE SIGNS LIST

1 Image display device

1a Image display device

1b Image display device

1c Image display device

11 First image generation unit

12 Second image generation unit

21 First display panel

22 Second display panel

30 Projection optical system

53 Liquid crystal

59 Pixel electrode

71 Counter electrode

108 Reflection unit

110 Projection optical system

200 Detection unit

300 Control unit

1. An image display device capable of projecting an optical image, the image display device comprising:
a reflection unit that reflects the optical image;
a projection optical system that projects the optical image reflected;
a detection unit that detects a motion of the image display device; and
a control unit that controls a projection angle of the optical image by changing a reflection characteristic of a constituent material included in the reflection unit according to the motion.

2. The image display device according to claim 1,
wherein the control unit controls the projection angle by changing an orientation of the constituent material.

3. The image display device according to claim 1,
wherein the front reflection unit includes:
a plurality of pixel electrodes disposed in a matrix manner;
a counter electrode including a conductive film facing the plurality of pixel electrodes; and
the constituent material disposed on the plurality of pixel electrodes and the counter electrode, and
the control unit controls an orientation of the constituent material by changing a potential between the plurality of pixel electrodes and the counter electrode.

4. The image display device according to claim 1,
wherein the control unit changes a position of a reflection region in a reflection surface of the reflection unit by changing an orientation of the constituent material.

5. The image display device according to claim 1,
wherein the control unit controls a position of a reflection region in the reflection unit by changing light transmittance of the constituent material.

6. The image display device according to claim 1,
wherein the constituent material is a phase modulation element.

7. The image display device according to claim 6,
wherein the control unit changes an angle at which the optical image is reflected by changing an orientation of the phase modulation element.

8. The image display device according to claim 6,
wherein the control unit changes a range in which the optical image is reflected by changing an orientation of the phase modulation element.

9. The image display device according to claim 1, further comprising
an image generation unit that generates the optical image in a two-dimensional manner on a basis of a video signal,
wherein the control unit changes a relative position between a position where the optical image is generated and a position of a reflection region in the reflection unit according to the motion.

10. The image display device according to claim 9,
wherein the image generation unit includes a liquid crystal panel in which transmittance or reflectance of light is controlled by the control unit on a basis of the video signal.

11. The image display device according to claim 9,
wherein the control unit changes a position at which the optical image is generated to a position corresponding to the reflection region of the reflection unit.

12. The image display device according to claim 1,
wherein the control unit changes the projection angle on a basis of a statistic of a movement amount detected by the detection unit in a predetermined period.

13. The image display device according to claim 1, further comprising
a second image generation unit that generates a second optical image in a two-dimensional manner on a basis of a video signal; and
a 2 reflection unit that reflects the second optical image,
wherein the projection optical system performs projection to superimpose the optical image reflected and the second optical image reflected, and
the control unit controls at least one of the second image generation unit or the second reflection unit such that a projection angle of the second optical image projected from the projection optical shape is changed according to the motion.

14. A control method of an image display device comprising:
a reflection unit that reflects an optical image;
a projection optical system that projects the optical image reflected; and
a detection unit that detects a motion of the reflection unit,
wherein the control method controls a projection angle of the optical image by changing an orientation of a constituent material constituting the reflection unit according to the motion.

15. A control method of an image display device comprising:
a reflection unit that reflects an optical image;
a projection optical system that projects the optical image reflected; and
a detection unit that detects a motion of the reflection unit,
wherein the control method controls a projection angle of the optical image by changing a position of the optical image incident on the reflection unit according to the motion.
